(19) United States
(12) Patent Application Publication
(10) Pub. No.: US 2023/0412562 A1
(43) Pub. Date: Dec. 21, 2023

(54) Filtering System, Computer-Executed Method for Filtering to Restrict Access to the Internet, and Computer-Readable Recording Medium

(71) Applicant: Konica Minolta, Inc., Tokyo (JP)

(72) Inventor: Hikaru MUTO, Itami-shi (JP)

(73) Assignee: Konica Minolta, Inc., Tokyo (JP)

(21) Appl. No.: 18/332,162

(22) Filed: Jun. 9, 2023

(30) Foreign Application Priority Data
Jun. 15, 2022 (JP) 2022-096423

(51) Int. Cl. H04L 9/40

(52) U.S. Cl. CPC H04L 63/0236; H04L 63/102

(57) ABSTRACT

A filtering system restricts access to the Internet by User A and User B supervised by User A. The filtering system includes a first terminal to be used by User A, and a second terminal to be used by User B. Access to the Internet by the first terminal is restricted by a first filter. Access to the Internet by the second terminal is restricted by a second filter. The first terminal acquires restriction information indicating access restriction by the second filter, and displays information indicating whether or not the second user can access a predetermined website, based on the acquired restriction information.

The present application claims priority to Japanese Patent Application No. 2022-096423, filed on Jun. 15, 2022, the disclosure of which is incorporated herein by reference in its entirety.

### BACKGROUND

### Technological Field

The present disclosure relates to a filtering system, a computer-executed method for filtering to restrict access to the Internet, and a computer-readable recording medium.

### Description of the Related Art

In recent years, there have been filtering services restricting access to websites that may have negative impacts on those who are under protection. Such filtering services can restrict access to a website such as Internet shopping site or social media site by a terminal used by a user not skilled in making judgements such as child. In this way, the filtering services can suppress overcharging by shopping sites, occurrence of troubles with other users on social media, and the like.

A filtering system may restrict access to websites to which access should not be restricted essentially. Japanese Laid-Open Patent Publication No. 2010-117874 discloses a filtering system that enables a person under protection to request his or her guardian to lift restriction on access to a predetermined website. When the guardian determines that the request to lift the access restriction is valid and permits lifting of the access restriction, the guardian transmits, to a filtering server, an instruction to lift the access restriction.

Such a filtering system may be used not only by each family but also by various organizations such as schools and companies, for example. When the filtering service is applied to a school, the filtering service may restrict access by both terminals for teachers and terminals for students that are supplied by a municipality. In this case, the terminals for teachers and the terminals for students may be subjected to filtering on different conditions.

### SUMMARY

At a school into which the filtering system is introduced, a teacher may share a link of a predetermined website with students' terminals for a class. At this time, the teacher cannot determine whether the predetermined website can be accessed by the students' terminals.

If a link of an access-restricted website is shared inadvertently with students' terminals, the students cannot access the website and accordingly request the teacher to lift the access restriction. Further, the teacher accordingly makes a request to an administrator of a filtering server for lifting of the access restriction, which involves a complicated procedure for making the request for the lifting.

The present disclosure is made in view of these circumstances, and an object of the present disclosure is to provide a filtering system that enables a supervisor to easily confirm whether a terminal of a supervised person can access a predetermined website.

To achieve at least one of the abovementioned objects, according to an aspect of the present invention, a filtering system of the present disclosure reflecting one aspect of the present invention is a filtering system restricting access to the Internet by a first user and a second user supervised by the first user. The filtering system includes: a first terminal to be used by the first user; and a second terminal to be used by the second user. Access to the Internet by the first terminal is restricted by a first filter, and access to the Internet by the second terminal is restricted by a second filter. The first terminal acquires restriction information indicating access restriction by the second filter, and displays information indicating whether or not the second user can access a predetermined website, based on the acquired restriction information.

To achieve at least one of the abovementioned objects, according to an aspect of the present invention, a method of the present disclosure reflecting one aspect of the present invention is a computer-executed method for filtering that restricts access to the Internet by a first user and a second user supervised by the first user. The method includes: restricting access to the Internet by the first user and the second user, by using a first filter and a second filter, respectively; acquiring restriction information indicating access restriction by the second filter; and displaying, to the first user, whether or not the second user can access a predetermined website, based on the restriction information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 shows an overall configuration of a filtering system.

FIG. 2 is a block diagram showing hardware configurations of terminals and servers according to the present embodiment.

FIG. 3 shows a first example of a browser screen displayed by a teacher's terminal.

FIG. 4 shows a second example of the browser screen displayed by the teacher's terminal.

FIG. 5 shows a third example of the browser screen displayed by the teacher's terminal.

FIG. 6 shows a fourth example of the browser screen displayed by the teacher's terminal.

FIG. 7 is a flowchart showing a process procedure used for the filtering system according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of technical ideas according to the present disclosure are hereinafter described. In the following description, the same components are denoted by the same reference characters. They have the same names and functions as well. Therefore, a detailed description thereof is not herein repeated.

### EMBODIMENTS

### <Overall Configuration of Filtering System>

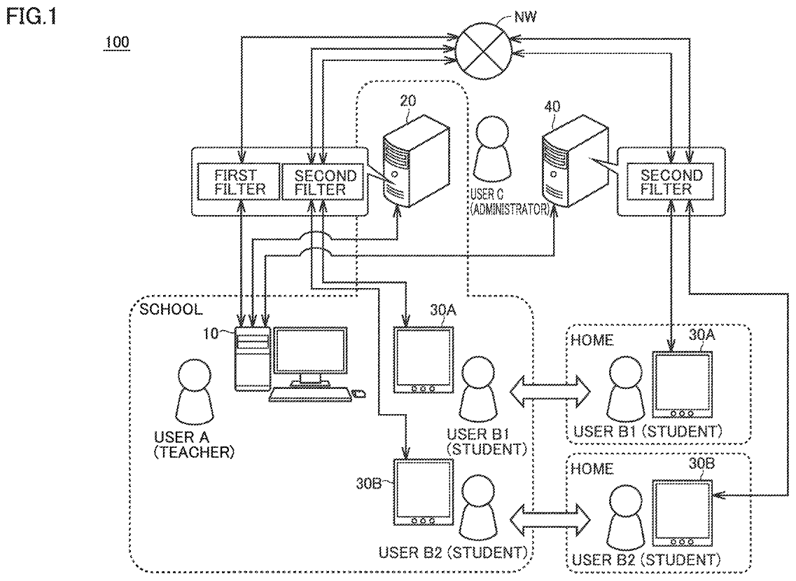

FIG. 1 shows an overall configuration of a filtering system 100. In the following, an example is described in which filtering system 100 according to the present embodiment is applied to an educational institution such as school. Filtering system 100 of the present disclosure is applicable not only to educational institutions such as school, but also to various organizations including a supervisor(s) and a supervised person(s). For example, filtering system 100 of the present disclosure is also applicable to a company, a non-commercial organization, and each family.

As shown in FIG. 1, filtering system 100 according to the present embodiment includes a teacher's terminal 10, a server 20 placed in the school, students' terminals 30A, 30B, and a server 40 placed outside the school. Terminals 10, 30A, 30B and servers 20, 40 are electrically connected to each other. Terminals 10, 30A, 30B are connected to the Internet NW through servers 20, 40. In the following, students' terminals 30A, 30B may collectively be referred to simply as “terminal 30.”

Terminal 10 is a terminal to be used by User A who is a teacher. Terminal 10 according to the present embodiment is a desktop-type PC. Terminals 30A, 30B are terminals to be used respectively by Users B1, B2 who are students. Terminals 30A, 30B according to the present embodiment are tablet-type terminals, for example. Terminals 10, 30A, 30B are supplied to the teacher and students by a municipality or an educational institution such as school, for the purpose of promoting classes. In the following, Users B1, B2 who are students may collectively be referred to simply as “User B.”

While an example is illustrated, in the present embodiment, in which filtering system 100 is applied to an organization constituted by one teacher and two students, the number of teachers and the number of students are not limited to one and two, respectively. For example, the number of teachers may be two or more. The number of students may be one, 30, or 100, for example.

User A who is a teacher instructs each student in a classroom of the school to access a predetermined website by means of terminal 30A, 30B during a class, for example. User A who is a teacher may also give the students an assignment to watch a video distributed from a predetermined website. In this case, Users B1, B2 who are students bring terminals 30A, 30B from the school to their homes.

As shown in FIG. 1, terminals 10, 30A, 30B in the school are connected to the Internet NW through a filter in server 20. Server 20 has a filtering function to restrict access to the Internet. In the present embodiment, server 20 is placed in the school and performs filtering on terminals 10, 30A, 30B in the school. Server 20 may be placed not in the school but in an external data center, or an office or the like of a board of education for each city/town/village having the jurisdiction over a plurality of schools.

As shown in FIG. 1, User C is an administrator of a filtering service implemented by server 20 and server 40. The filtering service is provided by User C. As shown in FIG. 1, server 20 performs filtering by means of a first filter and a second filter, and server 40 performs filtering by means of the second filter. The filter is a condition or an algorithm indicating details of restriction on access to the Internet. In the present embodiment, the filter may be either a filter of a white list type or a filter of a black list type.

The second filter for the students is a filter that imposes a stricter restriction than the first filter for the teacher. Specifically, the total number of websites that can be accessed through the second filter is smaller than the total number of websites that can be accessed through the first filter.

The second filter suppresses students' access to a website that may have negative impacts on the students, and therefore, it is desirable to impose, by the second filter, a strict restriction on access to the Internet. In contrast, User A who is a teacher uses terminal 10 to perform wide-ranging works such as perusing, on terminal 10, websites to be used for classes, as well preparation for classes, preparation of materials, and making of a teaching plan. In other words, it is enough for the students to have access to only the websites to be used for classes, while the teacher should have access to websites that cannot be accessed by the students. It is therefore necessary to perform appropriate filtering for both the students and the teacher.

As shown in FIG. 1, when each of Users B1, B2 at home accesses the Internet through terminals 30A, 30B, terminals 30A, 30B accesses the Internet through server 40. Server 40, like server 20, restricts access to the Internet by terminals 30A, 30B for students, by means of the second filter. Thus, filtering system 100 according to the present embodiment can restrict access by the students, by means of the second filter, regardless of whether each student resides at home or school.

In filtering system 100 according to the present embodiment, teacher's terminal 10 acquires, from servers 20, 40, restriction information indicating access restriction by the second filter. The restriction information includes a condition and/or an algorithm under which access is restricted by the second filter. Based on the acquired restriction information, teacher's terminal 10 displays information indicating whether User B can access a predetermined website. Specifically, User A who is a teacher can use teacher's terminal 10 to confirm the state of restriction on the Internet access by Users B1, B2 who are students.

### <Configurations of Terminals 10, 30 and Servers 20, 40>

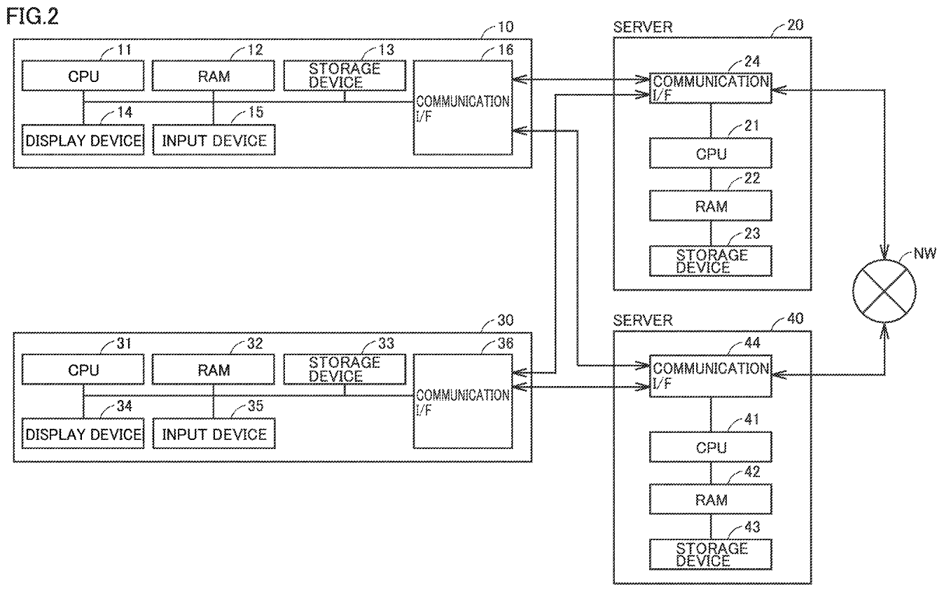

FIG. 2 is a block diagram showing hardware configurations of terminals 10, 30 and servers 20, 40 according to the present embodiment. As shown in FIG. 2, teacher's terminal 10 and student's terminal 30 have similar configurations. In the following, the configuration of terminal 10 is described, and the description is not repeated for terminal 30 having the similar configuration to terminal 10.

Terminal 10 includes, as main components, a CPU 11 that executes a program, a RAM 12 that stores temporarily (in volatile manner) data generated through execution of the program by CPU 11, or externally input data, a storage device 13 that stores data in non-volatile manner, such as hard disk, a display device 14, an input device 15, and a communication interface (I/F) 16. The program includes, not only a program directly executable by CPU 11, but also a program in a source program form, a compressed program, and an encrypted program, for example. These components of terminal 10 are connected to each other through a data bus.

Processing in terminal 10 is implemented through cooperation between each hardware component and software executed by CPU 11. As mentioned above, terminal 10 according to the present embodiment is a desktop-type computer, which, however, may also be an information communication device such as laptop-type computer, tablet terminal, or smartphone, for example. Terminal 30 according to the present embodiment is a tablet-type terminal, which, however, may also be an information communication device such as desktop-type computer, laptop-type computer, or smartphone, for example.

Storage device 13 is not limited to a hard disk, but may be a recording medium that carries a program in a stationary manner, such as CD-ROM, FD (Flexible Disk), magnetic tape, cassette tape, optical disc (MO (Magnetic Optical Disc)/MD (Mini Disc)/DVD (Digital Versatile Disc)), IC (Integrated Circuit) card (including memory card), optical card, mask ROM, EPROM (Electronically Programmable Read-Only Memory), EEPROM (Electronically Erasable Programmable Read-Only Memory), and semiconductor memory such as flash ROM.

Display device 14 is implemented for example by an organic EL (Electro Luminescence) display, a liquid crystal display, or the like. Input device 15 is, for example, a button, a mouse, and/or a keyboard receiving input of an instruction from a user. Display device 14 and input device 15 may also be integrated into a touch panel.

As shown in FIG. 2, server 20 and server 40 have similar configurations. In the following, the configuration of server 20 is described, and the description is not repeated for server 40 having the similar configuration to server 20.

Server 20 includes, as main components, a CPU 21 that executes a program, a RAM 22 that stores temporarily (in volatile manner) data generated through execution of the program by CPU 21, or externally input data, a storage device 23 that stores data in non-volatile manner, such as hard disk, and a communication interface (I/F) 24. These components are connected to each other through a data bus.

Server 20 is a server owned by a business entity that provides the filtering service, for example. Server 20 performs comprehensive processing for controlling the filtering service. The processing by server 20 is implemented through cooperation between each hardware component and software executed by CPU 21. The software executed by server 20 may be generated by the business entity providing the filtering service, and stored in advance in storage device 23.

The software to be executed by server 20 is read by CPU 21 from storage device 23 and stored in RAM 22 in the form of an executable program. CPU 21 executes this program. The software to be executed by server 20 may be provided, through the Internet, from a business entity providing the filtering service, in the form of a downloadable application program. The software may also be stored in a recording medium such as CD-ROM (Compact Disc-Read Only Memory) and distributed as a computer program.

Such software is read from the recording medium by a reader such as optical disc driver (not shown), or downloaded through communication interface 24, and thereafter stored temporarily in storage device 23. The software is read from storage device 23 by CPU 21, and stored in RAM 22 in the form of an executable program. CPU 21 executes the program. The recording medium may include a non-transitory (nonvolatile) computer-readable data recording medium. Operations of respective hardware components of terminals 10, 30 and servers 20, 40 are well-known, and therefore, a detailed description is not herein repeated.

In the present embodiment, respective programs associated with the first filter and the second filter are stored in storage device 23 of server 20. A program associated with the second filter is stored in a storage device 43 of server 40.

As shown in FIG. 2, for the Internet access restriction on the student by the second filter, student's terminal 30 is connected to each of server 20 and server 40. For the Internet access restriction on the teacher by the first filter, teacher's terminal 10 is connected to server 20. Further, in order to acquire restriction information about access restriction on the students, teacher's terminal 10 is connected to server 40 in addition to server 20.

<Display, by Teacher's Terminal 10, Information about Access Restriction on Student's Terminal 30>

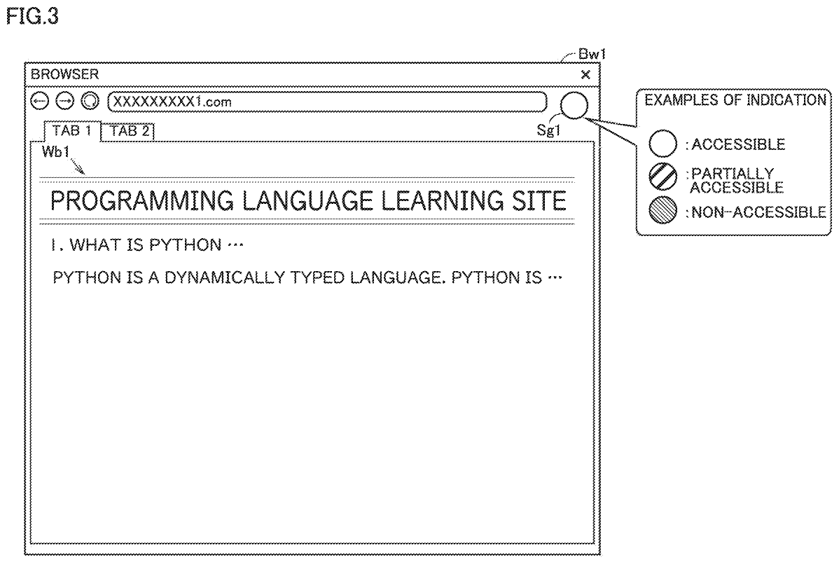

FIG. 3 shows a first example of a browser screen displayed by teacher's terminal 10. As described above in connection with FIG. 1, terminal 10 acquires, from servers 20, 40, restriction information indicating access restriction by the second filter, and displays, based on the acquired restriction information, whether or not User B who is a student can access a predetermined website.

Browser screen Bw1 illustrated in FIG. 3 is shown on a display of teacher's terminal 10. FIG. 3 shows an example where User A who is a teacher causes a website Wb1 for learning the programming language to be displayed by a browser of terminal 10. Website Wb1 to be used for a class is not a site that may have negative impacts on the students, but a website that provides useful information for the students. Website Wb1 is therefore access-restricted by none of the first filter and the second filter. In other words, each of User A who is a teacher and User B who is a student can cause website Wb1 to be displayed through its terminal 10, 30.

An indicator Sg1 is provided at the upper right end of browser screen Bw1. Indicator Sg1 is an indication for showing whether or not terminal 30 of the student to be supervised can access website Wb1. As shown in FIG. 3, depending on whether or not the student can access website Wb1, the indication presented by indicator Sg1 varies. FIG. 3 shows three states regarding restriction on student's access to website Wb1, namely, “accessible” state, “partially accessible” state, and “non-accessible” state. For each state, indicator Sg1 presents a different indication. While indicator Sg1 expresses each state by hatching in the present embodiment, the color of indicator Sg1 may be changed, or test information may be added to indicator Sg1, for example.

As describe above, website Wb1 is a useful website for the students, and is therefore access-restricted by none of the first filter and the second filter. Thus, indicator Sg1 as shown in FIG. 3 presents the “accessible” state indicating that both Users B1 and B2 who are students can access the website.

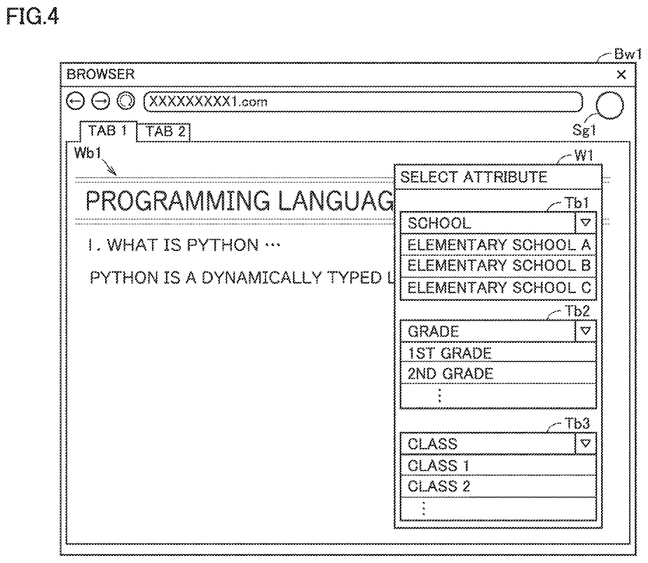

“Partially accessible” is a state where the access restriction is imposed on only apart of a plurality of students under supervision. In the following, the “partially accessible” state is described with reference to FIG. 4. FIG. 4 shows a second example of the browser screen displayed by teacher's terminal 10. As shown in FIG. 4, receiving an instruction from User A who is a teacher, teacher's terminal 10 causes display device 14 to display an attribute selection screen W1.

Attribute selection screen W1 is a screen for changing a group of students to be supervised, as indicated by indicator Sg1. Servers 20, 40 store attribute information about each student. As shown in FIG. 4, servers 20, 40 store hierarchical attribute information such as elementary school, grade, and class, to which each student belongs. User A who is a teacher can use a tab Tb1 to change the elementary schools to be supervised, and use a tab Tb2 to change the grades to be supervised, and use a tab Tb3 to change the classes to be supervised. User A who is a teacher can select, from attribute selection screen W1, an elementary school, a grade, and a class to be supervised by User A, to thereby recognize the state of access restriction on only those under supervision of User A.

Basically, servers 20, 40 use the second filter to restrict access by User B who is a student, and change conditions for the second filter depending on the user's attributes. For example, servers 20, 40 allow website Wb1 to be displayed to students of Elementary School A, and does not allow website Wb1 to be displayed to students of Elementary School B. Thus, filtering system 100 according to the present embodiment can change the conditions for the second filter for each attribute.

Indicator Sg1 indicates the “partially accessible” state when only Elementary School A is selected as attribute information while the attribute information about the grade and the class is not selected, and some websites are access-restricted for Grades 1 to 5 while the websites are not access-restricted for Grade 6, for example. In this case, among the students of Elementary School A to be supervised, only the Grade 6 students of Elementary School A can access the websites. In other words, this is the state where only a part of Users B to be supervised can access the websites.

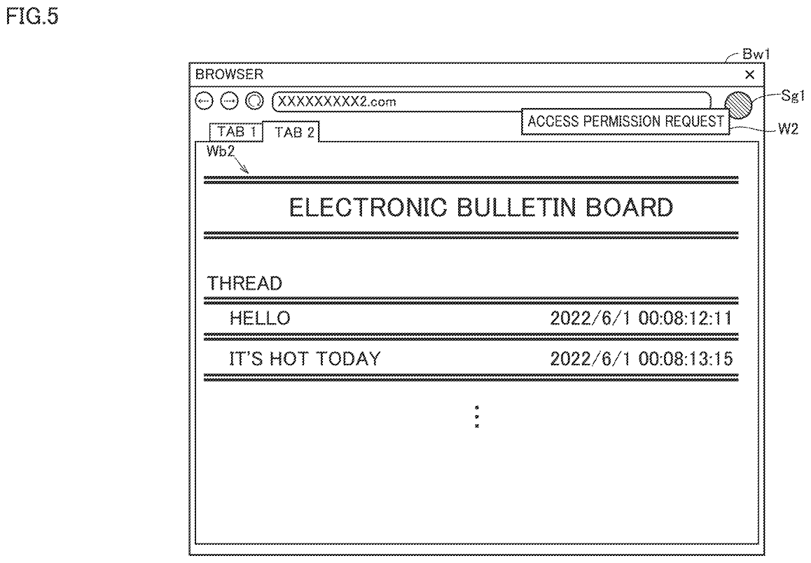

“Non-accessible” is a state where access restriction is imposed on all of a plurality of students under supervision. FIG. 5 shows a third example of the browser screen displayed by teacher's terminal 10. In FIG. 5, indicator Sg1 indicates the “non-accessible” state.

FIG. 5 shows an example where User A who is a teacher causes a website Wb2 that is an anonymous electronic bulletin board to be displayed by the browser of terminal 10. Website Wb2 is not a website to be used for a class, but a website that may have negative impacts on students. Therefore, as shown in FIG. 5, indicator Sg1 indicates the “non-accessible” state indicating that both Users B1, B2 who are students cannot access the website. Thus, filtering system 100 according to the present embodiment causes teacher's terminal 10 to display, for each state, an indication that whether a predetermined website can be accessed by student's terminal 30. Accordingly, filtering system 100 according to the present embodiment enables the teacher to easily recognize whether a predetermined website can be accessed by student's terminal 30.

A website that does not have negative impacts on students and that the teacher wants to use for a class may be access-restricted by mistake. In this case, User A who is a teacher causes an access permission request button W2 to be displayed. As shown in FIG. 5, receiving an instruction from User A who is a teacher, teacher's terminal 10 causes access permission request button W2 to be displayed. Access permission request button W2 is a button for requesting User C, i.e., an administrator, to lift the restriction on access to website Wb2. In response to right-click of a mouse on indicator Sg1, for example, terminal 10 causes access permission request button W2 to be displayed.

When access permission request button W2 is selected by User A, terminal 10 transmits, to servers 20, 40, information indicating a request for change. Accepting the request for change, User C authenticates User A and lift the restriction on access to website Wb2. Thus, filtering system 100 according to the present embodiment enables the request for lifting access restriction to be transmitted easily to User C, i.e., an administrator.

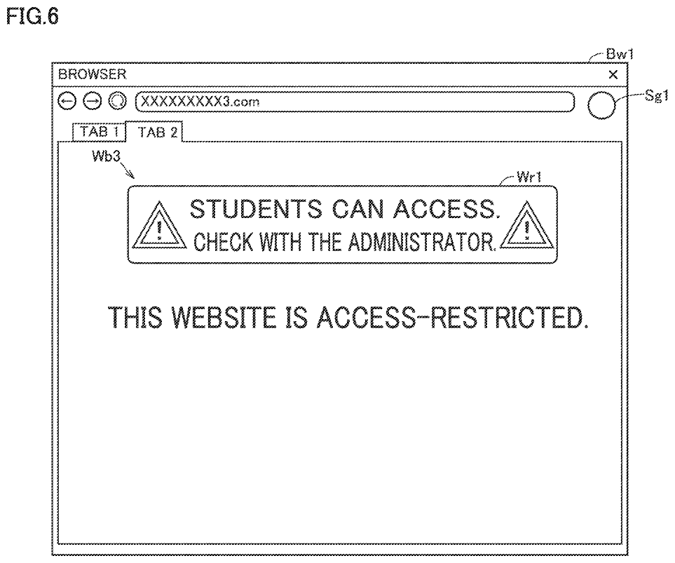

FIG. 6 shows a fourth example of the browser screen displayed by teacher's terminal 10. FIG. 6 shows an example where User A who is a teacher causes a website Wb3 to be displayed by the browser of terminal 10. Website Wb3 is not a website to be used for a class, but an access-restricted site for the teacher. Therefore, browser screen Bw1 indicates the characters “THIS WEBSITE IS ACCESS-RESTRICTED.” Specifically, the first filter makes website Wb3 non-accessible by terminal 10.

As shown by indicator Sg1 in FIG. 6, website Wb3 can be accessed by students. Specifically, website Wb3 is not access-restricted by the second filter, and can therefore be accessed by terminal 30. As described above, the second filter imposes a stricter restriction than the first filter. Therefore, in the example of FIG. 6, there is a possibility that an anomaly occurs to the first filter or the second filter.

As shown in FIG. 6, terminal 10 displays a warning indication Wr1 indicating that an anomaly occurs to the first filter or the second filter. On warming indication Wr1, the characters “STUDENTS CAN ACCESS. CHECK WITH THE ADMINISTRATOR.” are shown. Thus, when website Wb3 that is access-restricted by the first filter is not access-restricted by the second filter, terminal 10 displays an indication that an anomaly occurs to the first filter or the second filter.

### <Process Procedure>

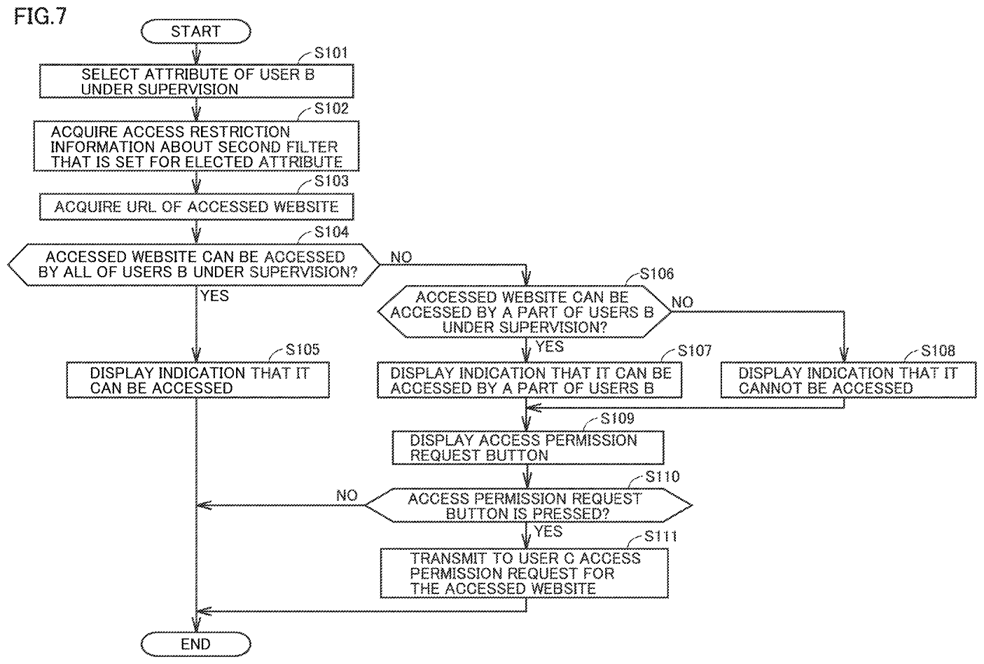

FIG. 7 is a flowchart showing a process procedure used for filtering system 100 according to the present embodiment. The flowchart of FIG. 7 is performed by terminal 10. Terminal 10 guides User A to select an attribute of User B to be supervised (step S101). Specifically, terminal 10 guides User A to select an attribute of User B to be supervised by User A, from attribute selection screen W1 described above with reference to FIG. 4. When User A does not select an attribute from attribute selection screen W1, Users B of all attributes are identified as users to be supervised, and the procedure proceeds to step S102.

Terminal 10 acquires access restriction information about the second filter which is set for the attribute selected in step S101 (step S102). Specifically, terminal 10 acquires the access restriction information about the second filter from server 20 or server 40 through the communication interface. Terminal 10 acquires the URL of a website being displayed by the web browser of terminal 10 (step S103).

Terminal 10 determines whether or not this accessed website can be accessed by all of Users B to be supervised (step S104). When the accessed website can be accessed by all of Users B to be supervised (YES in step S104), terminal 10 displays an indication that it can be accessed (step S105). Specifically, terminal 10 directs display device 14 to show indicator Sg1 indicating the “accessible” state.

When the accessed website cannot be accessed by all of Users B to be supervised (NO in step S104), terminal 10 determines whether the accessed website can be accessed by a part of Users B to be supervised (step S106). When the accessed website can be accessed by a part of Users B to be supervised (YES in step S106), terminal 10 displays an indication that it can be accessed by a part of Users B (step S107). Specifically, terminal 10 directs display device 14 to show indicator Sg1 indicating the “partially accessible” state.

When the accessed website cannot be accessed by a part of Users B to be supervised (NO in step S106), terminal 10 displays an indication that all of Users B cannot access the website (step S108). Specifically, terminal 10 directs display device 14 to show indicator Sg1 indicating the “non-accessible” state.

Receiving an instruction from User A after step S107 or step S108, terminal 10 displays access permission request button W2 (step S109). While an example is described above with reference to FIG. 5 in which access permission request button W2 is displayed in response to right-click with a mouse of terminal 10, terminal 10 may display, all the time, access permission request button W2 together with indicator Sg1 which indicates the “partially accessible” or “non-accessible” state, without receiving the instruction from User A.

Terminal 10 determines whether access permission request button W2 is pressed (step S110). When access permission request button W2 is not pressed (NO in step S110), terminal 10 ends the process. When access permission request button W2 is pressed (YES in step S110), terminal 10 transmits, to User C, an access permission request for the accessed website (step S111). Thus, filtering system 100 according to the present embodiment enables User A who is a teacher to recognize whether a predetermined website can be accessed by terminal 30 of User B who is a student.

Each time the browser newly accesses a website, terminal 10 performs the flowchart of FIG. 7. Specifically, in response to the new access to a website by User A, terminal 10 displays an indication of whether or not the accessed website can be accessed by User B. Thus, each time a website is accessed, the restriction information indicating whether or not the website can be accessed by User B is acquired, and therefore, even when the restriction information about the second filter is updated, the update can be reflected on the restriction information.

When the condition/algorithm for the second filter is changed, servers 20, 40 may inform User A of the change. More specifically, when the websites for which access is restricted by the second filter are changed based on update of setting by User C, servers 20, 40 transmit information indicating the update to terminal 10. Thus, even when User A does not open the browser, User A can recognize, in real time, the update of the second filter.

Further, each step of the flowchart shown in FIG. 7 may be performed not only by terminal 10 but also by servers 20, 40. For example, the determination in steps S104, S106 may be performed by servers 20, 40. In this case, servers 20, 40 acquire the attribute information and the website's URL from terminal 10 in steps S101 and S103, respectively.

While an example is described above with reference to FIG. 1 in which both of servers 20 and 40 use the second filter to impose access restriction on Users B who are students, the filter used by server 20 and the filter used by server 40 may be different from each other. For example, server 40 uses a third filter that is stricter than the second filter used by server 20. User A who is a teacher cannot directly supervise each student at home, and therefore, the access restriction on the student at home may be made stricter.

While FIG. 1 illustrates a configuration in which both of servers 20 and 40 are provided, a server to be connected by terminal 30 at home may be server 20. Specifically, filtering system 100 according to the present embodiment may have server 20 only.

### BRIEF SUMMARY

(Clause 1) A filtering system 100 restricts access to the Internet by User A and User B supervised by User A. Filtering system 100 includes: a terminal 10 to be used by User A; and a terminal 30 to be used by User B. Access to the Internet by terminal 10 is restricted by a first filter, and access to the Internet by terminal 30 is restricted by a second filter. Terminal 10 acquires restriction information indicating access restriction by the second filter, and displays information indicating whether or not User B can access a predetermined website, based on the acquired restriction information.

Thus, filtering system 100 enables User A who is a supervisor to recognize whether or not a predetermined website can be accessed by User B.
(Clause 2) Filtering system 100 according to Clause 1, wherein in response to access to a website by User A, terminal 10 displays whether User B can access the website accessed by User A.

Thus, each time the website is accessed, the information indicating whether the website can be accessed by User B is acquired, and therefore, even when the restriction information about the second filter is updated, the information on which the update is reflected can be displayed.
(Clause 3) Filtering system 100 according to Clause 1 or 2, wherein when a website that is access-restricted by the first filter is not access-restricted by the second filter, terminal 10 displays an indication that an anomaly occurs to the first filter or the second filter.

Thus, when User B who is under supervision can access a website, in spite of the fact that User A who is a supervisor cannot access the website, User A can recognize the fact that some anomaly occurs to filter settings.
(Clause 4) Filtering system 100 according to any one of Clauses 1 to 3 further includes a server 20. Server 20 restricts, using the first filter, access to the Internet by terminal 10, and restricts, using the second filter, access to the Internet by terminal 30.

Thus, in a school environment, only server 20 can be used to restrict access by terminals 10, 30.
(Clause 5) Filtering system 100 according to Clause 4, wherein when the restriction information is updated, server 20 transmits, to terminal 10, information indicating that the restriction information is updated.

Thus, User A can recognize the fact that the access restriction information for User B has been updated.
(Clause 6) Filtering system 100 according to Clause 4 or 5, wherein terminal 10 displays an indication that User B cannot access the predetermined website, and transmits information indicating a change request to server 20, when terminal 10 receives the change request that is a request for change of the restriction information about the second filter so as to allow User B to access the predetermined website.

Thus, User A can make a request, to a server administrator, for lifting restriction for an access-restricted website.
(Clause 7) Filtering system 100 according to any one of Clauses 4 to 6, wherein User A supervises User B2 in addition to User B1, and filtering system 100 further includes a terminal 30B to be used by User B2. Server 20 restricts, using the second filter, access to the Internet by terminal 30B.

Thus, the system is also applicable to an organization in which a plurality of users B are supervised by User A.
(Clause 8) Filtering system 100 according to Clause 7, wherein server 20 stores attribute information about User B1 and User B2, and changes the restriction information about the second filter, depending on the attribute information.

Thus, access restriction can be imposed appropriately for each attribute.
(Clause 9) Filtering system 100 according to any one of Clauses 1 to 3 further includes a server 20 and a server 40 different from server 20. Server 20 restricts, using the first filter, access to the Internet by terminal 10.

Server 40 restricts, using the second filter, access to the Internet by terminal 30.

Thus, server 20 can be used in a school environment and server 40 can be used in a home environment, to impose access restriction on terminal 30.
(Clause 10) Filtering system 100 according to Clause 9, wherein when the restriction information is updated, server 40 transmits, to terminal 10, information indicating that the restriction information is updated.

Thus, User A can recognize the fact that the access restriction information for User B has been updated.
(Clause 11) Filtering system 100 according to Clause 9 or 10, wherein terminal 10 displays an indication that User B cannot access the predetermined website, and transmits information indicating a change request to server 40, when terminal 10 receives the change request that is a request for change of the restriction information about the second filter so as to allow User B to access the predetermined website.

Thus, User A can easily make a request, to User C, i.e., server administrator, for lifting restriction for an access-restricted website.
(Clause 12) Filtering system 100 according to any one of Clauses 9 to 11, wherein User A supervises User B2 in addition to User B1. Filtering system 100 further includes a terminal 30B to be used by User B2. Server 40 restricts, using the second filter, access to the Internet by terminal 30B.

Thus, the system is applicable to a case where a plurality of users are supervised by User A.
(Clause 13) Filtering system 100 according to Clause 12, wherein server 40 stores attribute information about User B1 and User B2, and changes the restriction information about the second filter, depending on the attribute information.

Thus, filtering can be performed depending on the attribute of a user under supervision.
(Clause 14) A computer-executed method for filtering that restricts access to the Internet by User A and User B supervised by User A is provided, and the method includes: restricting access to the Internet by User A and User B, by using the first filter and the second filter, respectively; acquiring restriction information indicating access restriction by the second filter; and displaying, to User A, whether or not User B can access a predetermined website, based on the restriction information.

Thus, filtering system 100 enables User A, i.e., supervisor, to recognize whether or not a predetermined website can be accessed by User B.
(Clause 15) A program causes a computer to execute the method according to Clause 14.

Although embodiments of the present invention have been described and illustrated in detail, the disclosed embodiments are made for purposes of illustration and example only and not limitation. The scope of the present invention should be interpreted by terms of the appended claims.

What is claimed is:

1. A filtering system that restricts access to the Internet by a first user and a second user supervised by the first user, the filtering system comprising:
a first terminal to be used by the first user; and
a second terminal to be used by the second user, wherein
access to the Internet by the first terminal is restricted by a first filter,
access to the Internet by the second terminal is restricted by a second filter, and
the first terminal
acquires restriction information indicating access restriction by the second filter, and
displays information indicating whether or not the second user can access a predetermined website, based on the acquired restriction information.

2. The filtering system according to claim 1, wherein
in response to access to a website by the first user, the first terminal displays whether or not the second user can access the website accessed by the first user.

3. The filtering system according to claim 1, wherein
when a website that is access-restricted by the first filter is not access-restricted by the second filter, the first terminal displays an indication that an anomaly occurs to the first filter or the second filter.

4. The filtering system according to claim 1, further comprising a first server, wherein
the first server
restricts, using the first filter, access to the Internet by the first terminal, and
restricts, using the second filter, access to the Internet by the second terminal.

5. The filtering system according to claim 4, wherein
when the restriction information is updated, the first server transmits, to the first terminal, information indicating that the restriction information is updated.

6. The filtering system according to claim 4, wherein
the first terminal
displays an indication that the second user cannot access the predetermined website, and
transmits information indicating a change request to the first server, when the first terminal accepts the change request that is a request for change of the restriction information about the second filter so as to allow the second user to access the predetermined website.

7. The filtering system according to claim 4, wherein
the first user supervises a third user in addition to the second user,
the filtering system further comprises a third terminal to be used by the third user, and
the first server restricts, using the second filter, access to the Internet by the third terminal.

8. The filtering system according to claim 7, wherein
the first server
stores attribute information about the second user and the third user, and
changes the restriction information about the second filter, depending on the attribute information.

9. The filtering system according to claim 1, further comprising a first server and a second server different from the first server, wherein
the first server restricts, using the first filter, access to the Internet by the first terminal, and
the second server restricts, using the second filter, access to the Internet by the second terminal.

10. The filtering system according to claim 9, wherein
when the restriction information is updated, the second server transmits, to the first terminal, information indicating that the restriction information is updated.

11. The filtering system according to claim 9, wherein
the first terminal
displays an indication that the second user cannot access the predetermined website, and
transmits information indicating a change request to the second server, when the first terminal accepts the change request that is a request for change of the restriction information about the second filter so as to allow the second user to access the predetermined website.

12. The filtering system according to claim 9, wherein
the first user supervises a third user in addition to the second user,
the filtering system further comprises a third terminal to be used by the third user, and
the second server restricts, using the second filter, access to the Internet by the third terminal.

13. The filtering system according to claim 12, wherein
the second server
stores attribute information about the second user and the third user, and
changes the restriction information about the second filter, depending on the attribute information.

14. A computer-executed method for filtering that restricts access to the Internet by a first user and a second user supervised by the first user, the method comprising:
restricting access to the Internet by the first user and the second user, by using a first filter and a second filter, respectively;
acquiring restriction information indicating access restriction by the second filter; and
displaying, to the first user, whether or not the second user can access a predetermined website, based on the restriction information.

15. A computer-readable recording medium storing a program that causes a computer to execute the method according to claim 14.
